(19) United States
(12) Patent Application Publication
(10) Pub. No.: US 2020/0186636 A1
(43) Pub. Date: Jun. 11, 2020

(54) ENABLING CALL TRANSFER USING HEADSET

(71) Applicant: Cisco Technology, Inc., San Jose, CA (US)

(72) Inventors: Patrick Lee Wall, Apex, NC (US); Vikas Vashisht, Morrisville, NC (US)

(21) Appl. No.: 16/211,759

(22) Filed: Dec. 6, 2018

(51) Int. Cl. H04M 1/725; H04M 1/05

(52) U.S. Cl. CPC H04M 1/72513; H04M 2250/02; H04M 1/05

(57) ABSTRACT

In one embodiment, a headset receives, via a first service type of a wireless connection between a first telephony device and the headset, call-session identifier data of an active call maintained by the first telephony device. Media associated with the active call is communicated via a second service type of the wireless connection between the headset and the first telephony device. The headset sends to a second telephony device via a first service type of a wireless connection between the second telephony device and the headset, the call-session identifier data to enable the active call to be transferred from the first telephony device to the second telephony device based on the call-session identifier data. The headset receives from the second telephony device via a second service type of the wireless connection between the second telephony device and the headset, media for the active call.

### TECHNICAL FIELD

The present disclosure relates generally to telecommunications and, more particularly, to transferring calls.

### BACKGROUND

A party to a call may use a headset for audio input/output for the call. The headset may be wirelessly connected to a telephony device, and may receive audio from the telephony device and send audio to the telephony device during the call. In today's open office environments, users may participate in calls at their desk using such a telephony device and headset. Since the headset is wirelessly connected to the telephony device during the call, the user is not physically tethered to the telephony device and this presents options to the user that are not otherwise available when a wired headset is used.

### BRIEF DESCRIPTION OF THE DRAWINGS

FIG. 1 is a block diagram illustrating a system that facilitates call transfer between telephony devices using a wireless headset, according to an example embodiment.

FIG. 2 is a block diagram of the wireless headset of FIG. 1 configured to facilitate call transfer, according to an example embodiment.

FIG. 3 is a block diagram illustrating a telephony device of FIG. 1 configured to facilitate call transfer, according to an example embodiment.

FIG. 4 is a sequence diagram illustrating a method by which call transfers is achieved between telephony devices using a wireless headset, according to an example embodiment.

FIG. 5 is a flowchart of a method depicting operations performed by the wireless headset to facilitate call transfer, according to an example embodiment.

FIG. 6 is a flowchart of a method depicting operations performed by a first telephony device to facilitate call transfer, according to an example embodiment.

FIG. 7 is a flowchart of a method depicting operations performed by a second telephony device to facilitate call transfer, according to an example embodiment.

### DESCRIPTION OF EXAMPLE EMBODIMENTS

### Overview

In accordance with one embodiment, a method is provided that is performed by a headset. The method includes receiving, at a headset via a first service type of a wireless connection between a first telephony device and the headset, call-session identifier data of an active call maintained by the first telephony device. The media associated with the active call is communicated via a second service type of the wireless connection between the headset and the first telephony device. The call-session identifier data is sent from the headset to a second telephony device via a first service type of a wireless connection between the second telephony device and the headset to enable the active call to be transferred from the first telephony device to the second telephony device based on the call-session identifier data. Media for the active call is received at the headset from the second telephony device via a second service type of the wireless connection between the second telephony device and the headset.

In accordance with another embodiment, a method is provided that is performed by a telephony device. The method includes receiving, at a second telephony device via a first service type of a wireless connection between the second telephony device and a headset, call-session identifier data of an active call to enable the active call to be transferred from a first telephony device to the second telephony device based on the call-session identifier data. Media for the active call is sent from the second telephony device to the headset via a second service type of the wireless connection between the second telephony device and the headset.

### Example Embodiments

A user of a telephony device may use a wireless headset during a call being conducted with the telephony device. For example, in today's open office environments, users typically take calls at their desk using a telephony device (e.g., a deskphone or a softphone client running on their computer), and a wireless headset. During a call, a user may wish to transfer the call from the telephony device (herein referred to as the first telephony device) currently being used for the call to another telephony device (herein referred to as the second telephony device), which, for example, may be located in a more desirable environment and/or may have (and/or have access to) a more desirable hardware setup. For example, the telephony device (to which the active call is desired to be transferred) may be a video conference endpoint located in a conference room. As another example, if a sensitive/private topic is to be discussed on a call, the user may wish to transfer the active call to a telephony device (desk phone, conference phone, small video conference endpoint, etc.) in a quiet room, away from the open office environment where discussion of the sensitive/private discussion may be overheard. Currently, one way for a user to be able to use another telephony device during a call is to hang-up the current call, move to a different location, and make a new call, this time using the other telephony device.

Techniques are described herein to use a wireless headset to enable an active call on a first telephony device to be transferred to a second telephony device based on call information received at the headset from the first telephony device and sent from the headset to the second telephony device.

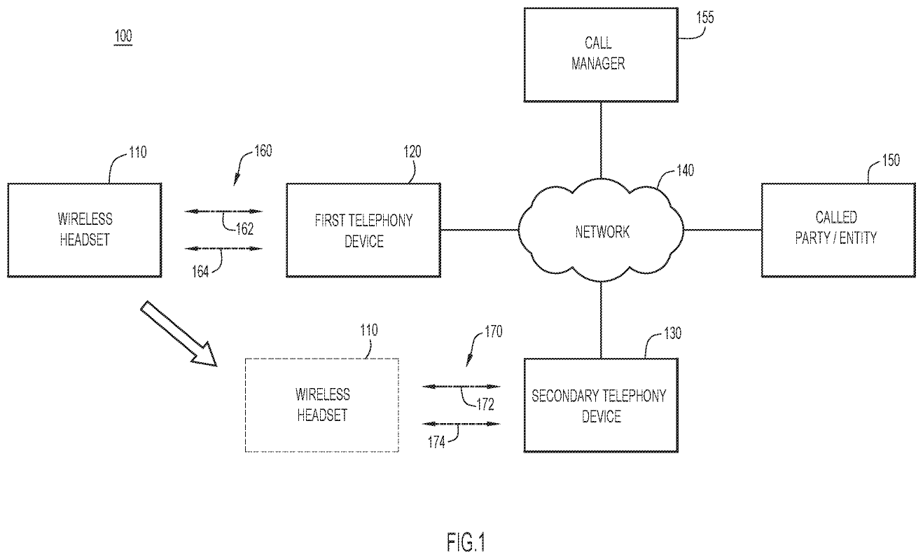

Reference is first made to FIG. 1. FIG. 1 shows a system 100 that includes a wireless headset 110, a first telephony device 120, a second telephony device 130, a network 140, and a called party/entity 150. The first telephony device 120, the second telephony device 130, and the called party/entity 150 are each capable of communicating with and/or through the network 140. Examples of types of networks that can be utilized within the system depicted in FIG. 1 include, without limitation, any one or more of local area networks (LANs), wide area networks (WANs), metropolitan area networks (MANs), Internet Protocol (IP) networks, such as intranet or internet networks, telephone networks (e.g., public switched telephone networks), wireless or mobile phone or cellular networks, etc., and/or any suitable combinations thereof. A call manager 155 may be provided that is used to manage calls to which the first telephony device 120 and the second telephony device 130 are participating in. The call manager 155 may include one or more software programs running on a server or in the cloud that are used to manage operations of an enterprise telephone system, of which the first telephony device 120 and second telephony device 130 are a part. The called party/entity 150 may be part of the same enterprise telephone system or outside of it.

The headset 110, first telephony device 120 and second telephony device 130 may be configured to perform relatively short-range wireless communication so that a user of the headset 110 can conduct a phone call (send and receive audio) using the first telephony device 120 or the second telephony device 130. In one example, the headset 110, the first telephony device 120, and the second telephony device 130 each enable wireless connectivity using Bluetooth® wireless communications technology. The headset 110 can communicate with the first telephony device 120 via a wireless connection 160, and in doing so the user of the headset 110 can have network connectivity with the called party/entity 150. The headset 110 can also communicate with the second telephony device 130 via a wireless connection 170.

In the illustrated example, the first telephony device 120 and the called party/entity 150 are in a telephone call/session established between the first telephony device 120 and the called party/entity 150 via the network 140. The first telephony device 120 and the called party/entity 150 exchange audio, video, and/or other data with each other through the network 140. The call/session may have been initiated by, for example, the first telephony device 120 or the called party/entity 150. Before and/or during the call, the wireless connection 160 may be established between the headset 110 and the first telephony device 120.

One or more service types of the wireless connection 160 may be employed to communicate media and/or other data between the headset 110 and the first telephony device 120. Call-session identifier data of the call may be communicated between the headset 110 and the first telephony device 120 via a first service type 162 of the wireless connection 160, and media associated with the call may be communicated between the headset 110 and the first telephony device 120 via a second service type 164 of the wireless connection 160. For example, the first telephony device 120 may send the call-session identifier data to the headset 110 via Near Field Communication (NFC), Bluetooth, ultrasound, etc. For example, the first telephony device 120 may send/relay media (e.g., audio data) associated with the call (e.g., received from the called party/entity 150 via the network 140) to the headset 110 via the second service type 164 of the wireless connection 160. In one example, in the case where the wireless connectivity is supported by Bluetooth technology, the first service type 162 that carries the call-session identifier data is the Bluetooth Low Energy (LE) service, and the second service type 164 is the Bluetooth Basic Rate/Enhanced Data Rate (BR/EDR) service. As is known in the art, the BR/EDR service is supported by different channels than the channels used by the BLE (also referred to herein as BTLE) service. Similarly, the headset 110 is capable of establishing a wireless connection 170 to the second telephony device 130, and that wireless connection 170 may include a first service type 172 (e.g., BLE, NFC, ultrasound, etc.) to carry call-session identifier data and a second service type 174 (e.g., BR/EDR) to carry media between the headset 110 and the second telephony device 130. Moreover, it is understood by those with ordinary skill in the art that the Bluetooth standard uses frequency hopping techniques.

In some embodiments, the first service type 162, via which the first telephony device 120 sends the call-session identifier data to the headset 110, is the same as the first service type 172, via which the headset 110 sends the call-session identifier data to the second telephony device 130. For example, the first telephony device 120 may send the call-session identifier data to the headset 110 using BLE, and the headset 110 may send the call-session identifier data to the second telephony device 130 using BLE. In some embodiments, the first service type 162, via which the first telephony device 120 sends the call-session identifier data to the headset 110, is different than the first service type 172, via which the headset 110 sends the call-session identifier data to the second telephony device 130. For example, the first telephony device 120 may send the call-session identifier data to the headset 110 using BLE, and the headset 110 may send the call-session identifier data to the second telephony device 130 using NFC.

After the call has been established between the first telephony device 120 and the called party/entity 150, a user associated with the headset 110 may wish to transfer the call from the first telephony device 120 to another telephony device (e.g., the second telephony device 130). For example, a user associated with the headset 110 may wish to transfer the call from the first telephony device 120 to the second telephony device 130 because of a location of or associated with the first telephony device 120 and/or the second telephony device 130, features/services of or associated with the first telephony device 120 and/or the second telephony device 130, and/or any other suitable reason. For example, a user associated with the headset 110 may wish to transfer the call from the first telephony device 120 to the second telephony device 130 because the second telephony device 130 is located in an environment that is more conducive for conducting the call (e.g., an environment that is quieter than the environment in which the first telephony device 120 is located) and/or the second telephony device 130 has more desirable hardware and/or software capabilities for conducting the call (e.g., the second telephony device 130 has better video input/output capabilities than the first telephony device 120).

In order for the call to be transferred from the first telephony device 120 to another telephony device, the call-session identifier data may be provided by the first telephony device 120 to the headset 110 via a service type of the wireless connection 160 that is different than a service type of the wireless connection 160 over which media associated with the call may be exchanged. The first telephony device 120 may provide the call-session identifier data to the headset 110 based on/in response to a call transfer request. For example, the first telephony device 120 may receive a call transfer request from the user, and based on the call transfer request, the first telephony device 120 may send to the headset 110 the call-session identifier data via the first service type 162 of the wireless connection 160. In one embodiment, the call transfer request may be initiated by the headset 110. For example, the user associated with the headset 110 may provide input to the headset 110 via a user interface of the headset 110 (e.g., the user may press a button on the headset 110 associated with initiating a call transfer request), and based on the received user input, the headset 110 may send a call transfer request to the first telephony device 120 via the first service type 162 of the wireless connection 160. In another embodiment, a call transfer request may be initiated at the first telephony device 120. For example, the user associated with the headset 110 may provide input that is indicative of a call transfer request to the first telephony device 120 via a user interface or button of the first telephony device 120.

In still another embodiment, the call-session identifier data is provided via the first service type 162 to the headset automatically at some point in time after the call is initially established by the first telephony device 120 with the called party/entity 150.

The headset 110, as described above, may send the call-session identifier data to the second telephony device 130 to enable the call to be transferred from the first telephony device 120 to the second telephony device 130 based on the call-session identifier data. For example, after the second telephony device 130 receives the call-session identifier data from the headset 110, the second telephony device 130 may send, via the network 140, the call-session identifier data and/or data based on the call-session identifier data to the call manager 155 in order to transfer the call from the first telephony device 120 to the second telephony device 130.

In one embodiment, after the headset 110 obtains the call-session identifier data, the headset 110 transmits an advertisement to discover a new telephony device capable of handling transfer of the call. In the illustrated example, the headset 110 transmits the advertisement via the first service type, and the second telephony device 130 (and possibly other telephony devices) receives the advertisement. For example, after/in response to receiving the call-session identifier data from the first telephony device 120, the headset 110 may transmit the advertisement via the first service type, so that telephony devices capable of receiving the advertisement (e.g., telephony devices that are within range of receiving the advertisement transmitted via the first service type from the first telephony device 120 and configured to receive the advertisement) may receive the advertisement. One or more of the telephony devices that receive the advertisement may, for example, display a name of or associated with the headset 110 and/or present a connection offer. The advertisement may include data indicative of the name. While the headset 110 transmits the advertisement, the headset 110 may continue to receive media of the call from the first telephony device 120 via the second service type 164 of the wireless connection 160, and in doing so, the user may continue to communicate on the call with the called party/entity 150 while the headset 110 discovers/attempts to discover a new telephony device capable of handling transfer of the call. The headset 110 may transmit/re-transmit the advertisement any suitable number of times and for any suitable duration. For example, the headset 110 may transmit/re-transmit the advertisement at predetermined regular or irregular intervals for a predetermined amount of time, until receiving a response from a telephony device, and/or until receiving user input.

The headset 110 may receive, from the second telephony device 130 via the first service type, a response indicating that the second telephony device 130 can handle transfer of the active call. The second telephony device 130 may present, via a user interface, a prompt/alert indicating that the second telephony device 130 is capable of handling transfer of the call and connecting to the headset 110. For example, in response to receiving the advertisement, the second telephony device 130 may present, via a user interface (e.g., display/screen) of the second telephony device 130, a prompt/alert requesting user input to allow (accept/confirm) the second telephony device 130 to connect to the headset 110 via the first service type to facilitate transfer of the call. The wireless connection 170 then may be established via the first service type between the second telephony device 130 and the headset 110. For example, the user associated with the headset 110 may provide input to the second telephony device 130 via a user interface of the second telephony device 130 (e.g., the user may press a button on the second telephony device 130 associated with connecting to the headset 110 to the second telephony device 130 to enable transfer of the call to the second telephony device 130), and based on the received user input, the wireless connection 170 may be established such that the headset 110 may send the second telephony device the call-session identifier data via the first service type 172 of the wireless connection 170. The second telephony device 130 may then use the call-session identifier data to pull over (transfer) the call.

In one embodiment, after the headset 110 obtains the call-session identifier data, the headset 110 scans for a new telephony device capable of handling transfer of the call. The new telephony device capable of handling transfer of the call, which, in the illustrated example, is the second telephony device 130, may transmit, via the first service type, an advertisement to indicate to other devices that it is capable of handling transfer of a call. The headset 110 may receive the advertisement via the first service type. The advertisement, for example, may include data/information corresponding to the second telephony device 130 that enables the headset 110 to send a response to the second telephony device 130 and/or establish the wireless connection 170. Based on/in response to receiving the advertisement, the headset 110 may send to the second telephony device 130, via the first service type of the wireless connection 170, the call-session identifier data.

In one embodiment, based on/in response to receiving the call-session identifier data, the second telephony device 130 presents a prompt/alert requesting user input to allow (accept/confirm) the second telephony device 130 to use the call-session identifier data to transfer the call to the second telephony device 130. In still another embodiment, the second telephony device 130 automatically at some point in time after receiving the call-session identifier data, uses the call-session identifier data to transfer the call to the second telephony device 130.

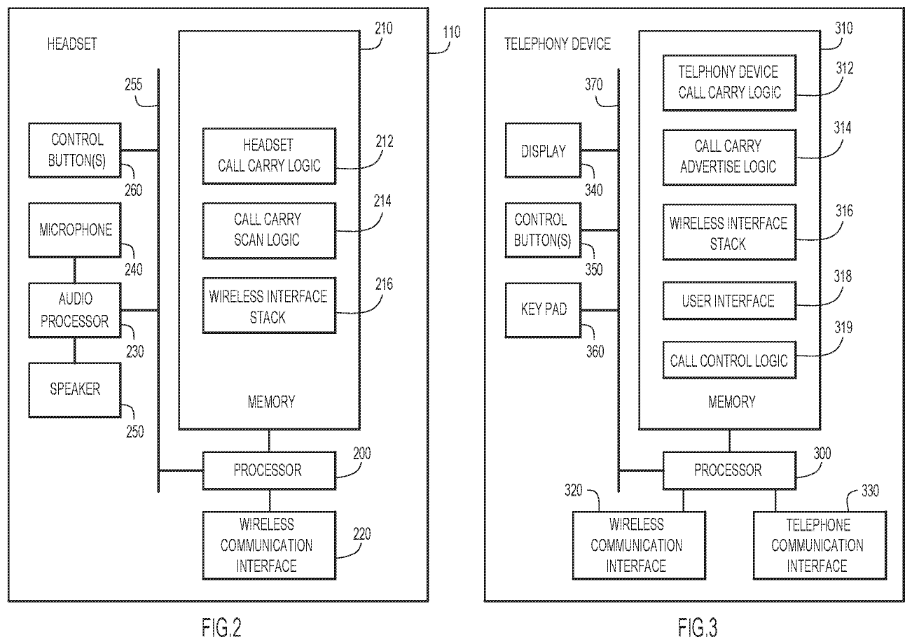

Further details of the capabilities and operations to perform the above-described call transfer mechanism are now described with reference to FIGS. 2-7.

FIG. 2 depicts a block diagram of the headset 110, according to an example embodiment. The headset 110 includes a processor 200, a memory 210, and a wireless communications interface 220. The processor 200 may be a microprocessor or microcontroller (or multiple instances of such components) that is configured to execute program logic instructions (i.e., software) for carrying out various operations and tasks described herein. For example, the processor 200 is configured to execute instructions for the headset call carry logic 212, the call carry scan logic 214, and the wireless interface stack 216 stored in the memory 210. The headset call carry logic 212 includes software instructions that when executed by the processor 200, cause the headset 110 to generate and send call transfer requests to a telephony device, receive call-session identifier data from a telephony device, send call-session identifier data to a telephony device, and establish a wireless connection with a telephony device. The call carry scan logic 214 includes software instructions that, when executed by the processor 200, cause the headset 110 to scan for (discover) telephony devices capable of accepting transfer of an active call in accordance with techniques described herein. The call carry scan logic 214 may additionally or alternatively include software instructions that, when executed by the processor 200, cause the headset 110 to advertise that it supports the call carry service. The wireless interface stack 216 includes software instructions that, when executed by the processor 200, cause the headset 110 to implement one or more protocols of a wireless communication protocol/standard, such as the Bluetooth® protocol stack, appropriate for a wireless headset. The wireless communication interface 220 includes the baseband and radio frequency (RF) integrated circuits that enable wireless connectivity between the headset 110 and at least one other device.

The headset 110 also includes an audio processor 230, a microphone 240 and a speaker 250. The audio processor 230 may consist of one or more integrated circuits that convert detected audio by the microphone 240 to digital signals that are supplied to the processor 200 for wireless transmission. The audio processor 230 may also convert received audio (via the wireless communication interface 220) to analog signals to drive the speaker 250. The audio processor 230 communicates with the processor 200 via bus 255.

The headset may further include one or more control buttons shown at 260 that interface with the processor 200 via bus 255. The buttons 260 may be used to control on/off hook and volume. A button may also be used to initiate a call transfer function.

The memory 210 may be read only memory (ROM), random access memory (RAM), magnetic disk storage media devices, optical storage media devices, flash memory devices, electrical, optical, or other physical/tangible memory storage devices. Thus, in general, the memory 210 may comprise one or more tangible (non-transitory) computer readable storage media (e.g., a memory device) encoded with software comprising computer executable instructions and when the software is executed (by the processor 200) it is operable to perform the operations described herein.

In one embodiment, the wireless communication interface 220 may be configured to enable wireless connectivity of first and second service types between the headset 110 and first and second telephony devices. The processor 200 may be configured to receive, via the first service type of a wireless connection with the first telephony device, call-session identifier data of an active call maintained by the first telephony device, wherein media associated with the active call is communicated via the second service type of the wireless connection with the first telephony device. The processor 200 may be configured to send, via the second service type of a wireless connection with the second telephony device, the call-session identifier data to enable the active call to be transferred from the first telephony device to the second telephony device based on the call-session identifier data. The processor 200 may be configured to receive, from the second telephony device via a second service type of the wireless connection with the second telephony device, media for the active call.

In one embodiment, the processor 200 is configured to transmit an advertisement via a first service type, to discover a new telephony device capable of handling transfer of the active call. The processor 200 may be configured to receive, from the second telephony device via the first service type, a response indicating that the second telephony device can handle transfer of the active call. The processor 200 may be configured to send the call-session identifier data based on the response. The processor 200 may be configured to establish a wireless connection via the second service type between the second telephony device and the headset 100. The processor 200 may be configured to transmit the advertisement based on a call-transfer request. The processor 200 may be configured to initiate the call-transfer request.

FIG. 3 depicts a block diagram of a telephony device and is representative of the first telephony device 120 and the second telephony device 130, according to an example embodiment. The telephony device includes a processor 300, a memory 310, a wireless communications interface 320, and a telephone communication interface 330. The processor 300 may be a microprocessor or microcontroller (or multiple instances of such components) that is configured to execute program logic instructions (i.e., software) for carrying out various operations and tasks described herein. The telephony device further includes a display (touch screen or non-touch screen) 340, one or more control buttons 350 and a keypad 360, all connected to the processor 300 via bus 370, for example.

For example, the processor 300 is configured to execute instructions for the telephony device call carry logic 312, the call carry advertiser logic 314, the wireless interface stack 316, the user interface logic 318, and the call control logic 319 stored in the memory 310. The telephony device call carry logic 312 includes software instructions that when executed by the processor 300, cause the telephony device to generate and/or receive call transfer requests, send and/or receive call-session identifier data to and/or from a headset, establish a wireless connection with a headset, and establish a call with a called party/entity via the telephone communication interface 330. The call carry advertiser logic 314 includes software instructions that, when executed by the processor 300, cause the telephony device to advertise that it supports the call carry service, or in other words, to be discoverable as a telephony device capable of transferring an active call in accordance with techniques described herein. The call carry advertiser logic 314 may additionally or alternatively include software instructions that, when executed by the processor 300, cause the telephony device to scan for (discover) headsets capable of sending call-session identifier data to transfer an active call in accordance with techniques described herein. The wireless interface stack 316 includes software instructions that, when executed by the processor 300, cause the telephony device to implement one or more wireless protocol, such as the Bluetooth® wireless technology protocol stack appropriate for a telephony device. The user interface logic 319 includes instructions that when executed by the processor 300 cause the processor to perform various user interface functions, such as activating a call transfer function so that the headset 110 can transfer a call maintained by the telephony device to another capable telephony device. One or more of the control buttons 350 may be dedicated to activating a call transfer function. The call control logic 319 includes software instructions that, when executed by the processor 300, cause the telephony device to establish a call. The wireless communication interface 320 enables wireless connectivity between the telephony device and a headset. The telephone communication interface 330 enables telephony connectivity between the telephony device and another telephony device.

The memory 310 may be ROM, RAM, magnetic disk storage media devices, optical storage media devices, flash memory devices, electrical, optical, or other physical/tangible memory storage devices. Thus, in general, the memory 310 may comprise one or more tangible (non-transitory) computer readable storage media (e.g., a memory device) encoded with software comprising computer executable instructions and when the software is executed (by the processor 300) it is operable to perform the operations described herein.

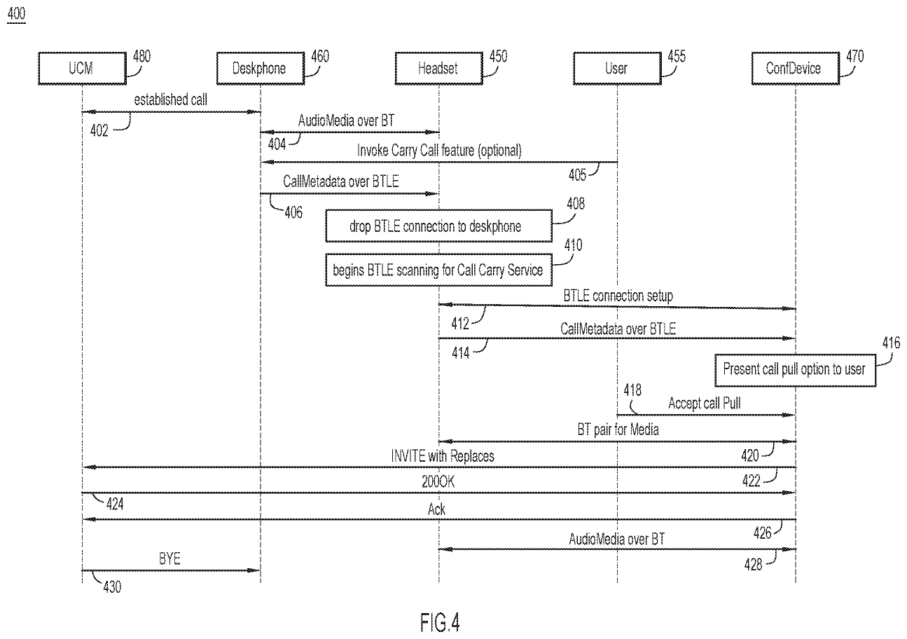

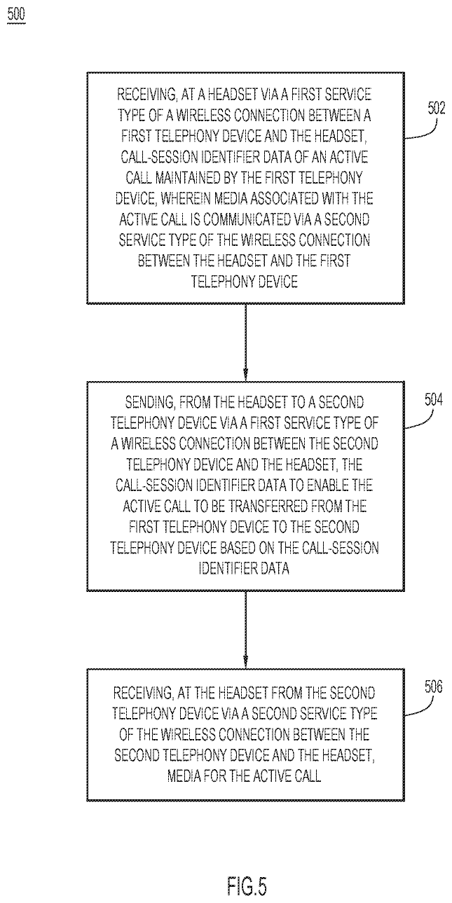

FIG. 4 is a sequence diagram illustrating a method 400 by which a wireless headset 450 transfers a call from a deskphone 460 to a conference device 470, according to an example embodiment. FIG. 4 shows a user 455 of the headset 450 and deskphone 460.

At 402, a call is established between the deskphone 460 and a called party/entity (not shown) via the unified communications/call manager (UCM) 480 (e.g., Cisco's unified communications/call manager (CUCM)), which may provide call control and session management, similar to the call manager 155 shown in FIG. 1. The deskphone 460 and the called party/entity are connected to the UCM 480 and can exchange audio, video, and/or other data with each other through the UCM 480. The deskphone 460 can communicate with the UCM 480 via a network (e.g., the network 140 shown in FIG. 1), and the UCM 480 can communicate with the called party/entity via the network 140 to establish the call.

At 404, the deskphone 460 and the headset 450 exchange, over a wireless connection (e.g., a Bluetooth wireless connection), audio media associated with the call. The media may be carried by the aforementioned first service type (e.g., BR-EDR). At 405, carry call feature may be invoked by the user 455 on the deskphone 460. At 406, the deskphone 460 sends to the headset 450, over a second service type (e.g., a BTLE service) of the wireless connection between the deskphone 460 and the headset 450, call metadata (call-session identifier data) of the call. At 408, the headset 450 drops/terminates the second service type (e.g., BTLE connection) to the deskphone 460 but maintains the wireless connection and in particular the first service type (e.g., BR-EDR service) that carries the media of the call.

At 410, the headset 450 may scan for one or more telephony devices that are capable of handling transfer of the call. In doing so, in the illustrated example, the headset 450 discovers that the conference device 470 is capable of handling transfer of the call. At 412, the headset 450 and the conference device 470 establish a wireless connection between them, and in particular set up a second service type connection (e.g., BTLE). At 414, the headset 450 sends to the conference device 470, over the established second service type connection, call metadata (call-session identifier data) of the call. The call metadata of the call is any identifying information of the call that enables the conference device 470 to facilitate transfer of the call to the conference device 470. For example, in an example where the Session Initiation Protocol (SIP) is employed for the call, the call metadata may include a SIP call ID for the call, a to tag for the call, and a from tag for the call, which may be used/included in a SIP INVITE with Replaces message to facilitate transfer of the call. As another example, a call park feature may be utilized, and the call metadata may include a park slot. It is to be understood, however, that the call metadata carried by the headset 110 from the first telephony device 120 to the second telephony device 130 to enable transfer of the call may include any suitable call metadata to enable transfer of the call, and the metadata that the headset 110 carries may be dependent upon a call control protocol employed.

At 416, the conference device 470 presents a call pull option via a user interface of the conference device 470 and/or a user interface of a device with which the conference device 470 is capable of communicating. For the example, the call pull option may be presented to alert the user 455 associated with the headset 450 that the call may be transferred to the conference device 470. At 418, the conference device 470 receives user input, via a user interface, that indicates acceptance of the call pull. For example, the conference device 470 may receive input via a user interface from the user 455 associated with the headset 450. At 420, the headset 450 and the conference device 470 establish (pair) a wireless connection of a first service type (e.g., BR-EDR) for exchanging media associated with the call.

At 422, the conference device 470 sends to the UCM 480 a SIP INVITE with Replaces message. For example, the SIP INVITE with Replaces message may be a SIP request to replace the existing call leg between the deskphone 460 and the UCM 480 with a call leg between the conference device 470 and the UCM 480. At 424, the conference device 470 receives from the UCM 480 a SIP response message indicating that the request was successful (e.g., a SIP 200 OK response). At 426, the conference device 470 sends to the UCM 480 a SIP acknowledgment message e.g., a SIP ACK message) to acknowledge that the conference device 470 received the SIP response (, and the call session may then be active, effectively transferring the call from the deskphone 460 to the conference device 470 so that the user 455 can continue with the call, using the headset 450, now paired with the conference device 470.

At 428, the headset 450 and the conference device 470 exchange media over their established wireless connection (e.g., BR-EDR). At 430, the UCM 480 sends a SIP BYE message to the deskphone 460 to terminate the call session with the deskphone.

As shown in FIG. 4, and described above in connection with FIG. 1, the mechanism presented herein allows a wireless headset device to transfer a call maintained by a first telephony device to a second telephony device so that the user can continue the call, using the headset, at the second telephone device, without the need for terminating the call and re-establishing the call.

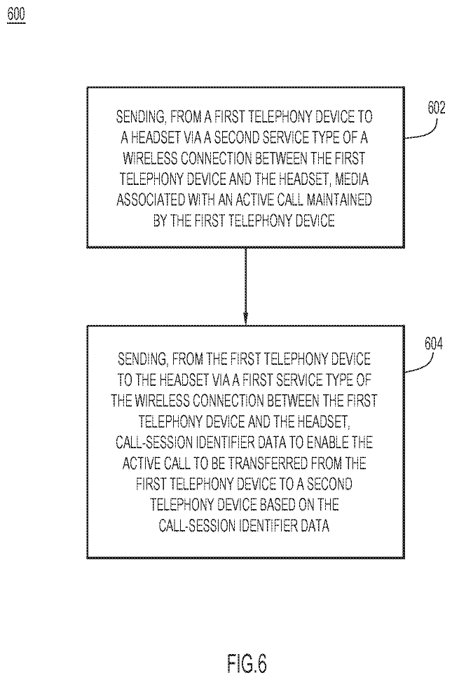

FIG. 5 is a flowchart illustrating a method 500 performed by a wireless headset to facilitate the call transfer mechanisms presented herein, according to an example embodiment. At 502, the headset receives, via a first service type of a wireless connection between a first telephony device and the headset, call-session identifier data of an active call maintained by the first telephony device. Media associated with the active call is communicated via a second service type of the wireless connection between the headset and the first telephony device. At 504, the headset sends to a second telephony device via a first service type of a wireless connection between the second telephony device and the headset, the call-session identifier data to enable the active call to be transferred from the first telephony device to the second telephony device based on the call-session identifier data. At 506, the headset receives from the second telephony device via a second service type of the wireless connection between the second telephony device and the headset, media for the active call.

In some embodiments, the headset may also transmit an advertisement, via a first service type to discover a new telephony device capable of handling transfer of the active call. In some embodiments, the headset may also receive from the second telephony device via the first service type a response indicating that the second telephony device can handle transfer of the active call. In some embodiments, the headset may also establish a wireless connection via the first service type between the second telephony device and the headset. In some embodiments, the headset may also maintain, via the second service type, the wireless connection between the headset and the first telephony device after the headset transmits the advertisement and at least until the headset sends the call-session identifier data to the second telephony device.

In some embodiments, the headset may send the call-session identifier data based on a call-transfer request. The call-transfer request may be initiated, for example, by the headset or at the first telephony device.

In some embodiments, the first service type may be a Bluetooth Low Energy (LE) channel.

In some embodiments, the second service type may be a Bluetooth Basic Rate/Enhanced Data Rate (BR/EDR) channel.

FIG. 6 is a flowchart illustrating a method 600 performed by a first telephony device at which a call has already been established, to facilitate the call transfer mechanisms presented herein, according to an example embodiment. At 602, the first telephony device sends to a headset via a second service type of a wireless connection between the first telephony device and the headset, media associated with an active call maintained by the first telephony device. At 604, the first telephony device sends to the headset via a second service type of the wireless connection between the telephony device and the headset, call-session identifier data (metadata) to enable the active call to be transferred from the first telephony device to a second telephony device based on the call-session identifier data (metadata).

In some embodiments, the first telephony device may initiate a request to transfer the active call from the first telephony device. In some embodiments, the first telephony device may send the call-session identifier data in response to the request being initiated.

In some embodiments, the first telephony device may receive a request to transfer the active call from the first telephony device. In some embodiments, the first telephony device may send the call-session identifier data (metadata) to the headset based on the request to transfer the active call. In some embodiments, the first telephony device receives the request to transfer the active call via a user interface of the first telephony device.

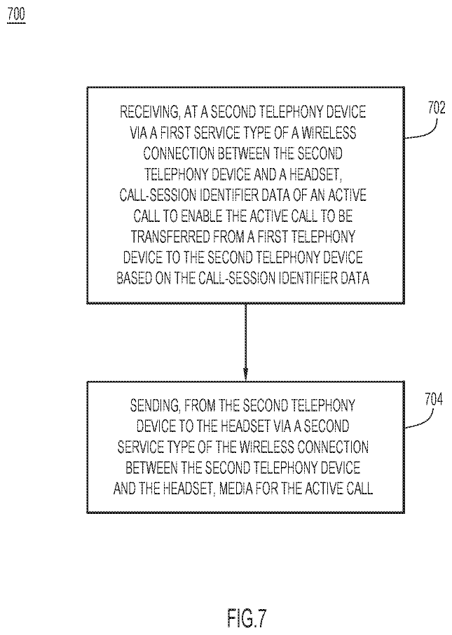

FIG. 7 is a flowchart illustrating a method 700 performed by a second telephony device to which a call is to be transferred, to facilitate the call transfer techniques presented herein, according to an example embodiment. At 702, the second telephony device receives via a first service type of a wireless connection between the second telephony device and a headset, call-session identifier data of an active call to enable the active call to be transferred from a first telephony device to the second telephony device based on the call-session identifier data. At 704, the second telephony device sends to the headset via a second service type of the wireless connection between the second telephony device and the headset, media for the active call.

In some embodiments, the second telephony device may receive via the first service type, an advertisement indicative of a request to discover a telephony device capable of handling transfer of the active call. In some embodiments, the second telephony device may send, via the first service type, a response indicating that the second telephony device can handle transfer of the active call. In some embodiments, the second telephony device may establish the wireless connection via the first service type between the second telephony device and the headset.

In some embodiments, the second telephony device may send a call-session transfer request based on the call-session identifier data to enable the active call to be transferred to the second telephony device. In some embodiments, the second telephony device may maintain the active call.

In some embodiments, the second telephony device may receive a user input to connect, via the first service type, the second telephony device to the headset. In some embodiments, the second telephony device may establish the wireless connection via the first service type between the second telephony device and the headset.

In some embodiments, the second telephony device may receive an input to transfer the active call to the second telephony device. In some embodiments the second telephony device may establish the wireless connection via the second service type between the second telephony device and the headset. In some embodiments, the second telephony device may send the call-session identifier data to a call manager to enable the transfer of the active call to the second telephony device from the first telephony device.

In some embodiments, the second telephony device may send to a call manager the call-session identifier data such that the active call is thereafter transferred to the second telephony device from the first telephony device. In some embodiments, the second telephony device may receive the media for the active call.

In some embodiments, the second telephony device may establish the wireless connection via the second service type between the second telephony device and the headset. In some embodiments, after the second telephony device establishes the wireless connection via the second service type, the second telephony device may receive an input indicative of confirmation to transfer the active call to the second telephony device. In some embodiments, the second telephony device may send to a call manager the call-session identifier data such that the active call is thereafter transferred to the second telephony device from the first telephony device.

As explained above, in methods depicted in FIGS. 5-7, the first service type may be a Bluetooth BR-EDR service channel and the second service type may be a Bluetooth LE service channel.

Using the techniques presented herein, a user of a wireless headset can invoke a new service (call carry service) on a first telephony device on an active call to enable transfer of the call to a second telephony device, where the user may be prompted to connect the wireless headset to and transfer the call to the second telephony device. The user can simply accept the prompt and continue the call. The techniques presented herein provide a seamless way to utilize the wireless headset to establish a signaling channel (separate from a channel used to carry media of the call) to carry the call-session identifier data (metadata) to transfer the active call from one telephony device to another.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

1. A method comprising:
receiving, at a headset via a first service type of a wireless connection between a first telephony device and the headset, call-session identifier data of an active call between the first telephony device and a call entity, wherein media associated with the active call is communicated via a second service type of the wireless connection between the headset and the first telephony device;
sending, from the headset to a second telephony device via a first service type of a wireless connection between the second telephony device and the headset, the call-session identifier data to enable the active call to be transferred from the first telephony device to the second telephony device based on the call-session identifier data;
establishing a wireless connection via the second service type between the second telephony device and the headset; and
receiving, at the headset from the second telephony device via a second service type of the wireless connection between the second telephony device and the headset, media for the active call.

2. The method of claim 1, further comprising:
transmitting an advertisement, by the headset, via a first service type, to discover a new telephony device capable of handling transfer of the active call; and
receiving, from the second telephony device via the first service type, a response indicating that the second telephony device can handle transfer of the active call.

3. The method of claim 2, further comprising:
maintaining, via the second service type, the wireless connection between the headset and the first telephony device after the transmitting of the advertisement at least until the sending of the call-session identifier data to the second telephony device.

4. The method of claim 1, wherein the sending of the call-session identifier data is based on a call-transfer request.

5. The method of claim 4, wherein the call-transfer request is initiated by the headset.

6. The method of claim 4, wherein the call-transfer request is initiated at the first telephony device.

7. The method of claim 1, wherein the first service type is a Bluetooth Low Energy (LE) channel.

8. The method of claim 1, wherein the second service type is a Bluetooth Basic Rate/Enhanced Data Rate (BR/EDR) channel.

9. An apparatus comprising:
a wireless communication interface configured to enable wireless connectivity of first and second service types between the apparatus and first and second telephony devices;
a memory; and
a processor configured to:
receive, via the first service type of a wireless connection with the first telephony device, call-session identifier data of an active call between the first telephony device and a call entity, wherein media associated with the active call is communicated via the second service type of the wireless connection with the first telephony device;
send, via the second service type of a wireless connection with the second telephony device, the call-session identifier data to enable the active call to be transferred from the first telephony device to the second telephony device based on the call-session identifier data;
establish a wireless connection via the second service type between the second telephony device and the apparatus; and
receive, from the second telephony device via a second service type of the wireless connection with the second telephony device, media for the active call.

10. The apparatus of claim 9, wherein the processor is further configured to:
transmit an advertisement via a first service type, to discover a new telephony device capable of handling transfer of the active call; and
receive, from the second telephony device via the first service type, a response indicating that the second telephony device can handle transfer of the active call.

11. The apparatus of claim 10, wherein the processor is configured to transmit the advertisement based on a call-transfer request via a first service type, to discover a new telephony device capable of handling transfer of the active call.

12. The apparatus of claim 11, wherein the processor is further configured to initiate the call-transfer request.

13. The apparatus of claim 10, wherein the processor is configured to send the call-session identifier data based on the response.

14. The apparatus of claim 11, wherein the first service type is a Bluetooth Low Energy (LE) channel and/or the second service type is a Bluetooth Basic Rate/Enhanced Data Rate (BR/EDR) channel.

15. A method comprising:
receiving, at a second telephony device via a first service type of a wireless connection between the second telephony device and a headset, call-session identifier data of an active call between a first telephony device and a call entity to enable the active call to be transferred from the first telephony device to the second telephony device based on the call-session identifier data;
establishing a wireless connection via a second service type between the second telephony device and the headset; and
sending, from the second telephony device to the headset via a second service type of the wireless connection between the second telephony device and the headset, media for the active call.

16. The method of claim 15, further comprising:
receiving, from the headset via the first service type, an advertisement indicative of a request to discover a telephony device capable of handling transfer of the active call;
sending, from the second telephony device via the first service type, a response indicating that the second telephony device can handle transfer of the active call; and
establishing the wireless connection via the first service type between the second telephony device and the headset.

17. The method of claim 15, further comprising:
receiving, at the second telephony device, an input to transfer the active call to the second telephony device; and
sending, from the second telephony device to a call manager, the call-session identifier data to enable the transfer of the active call to the second telephony device from the first telephony device.

18. The method of claim 15, wherein the first service type is a Bluetooth Low Energy (LE) channel and/or the second service type is a Bluetooth Basic Rate/Enhanced Data Rate (BR/EDR) channel.

19. The method of claim 15, further comprising:
sending, from the second telephony device to a call manager, the call-session identifier data such that the active call is thereafter transferred to the second telephony device from the first telephony device; and
receiving, at the second telephony device, the media for the active call.

20. The method of claim 15, further comprising:
after the establishing the wireless connection via the second service type, receiving, at the second telephony device, an input indicative of confirmation to transfer the active call to the second telephony device; and
sending, from the second telephony device to a call manager, the call-session identifier data such that the active call is thereafter transferred to the second telephony device from the first telephony device.
